(19) United States
(12) Patent Application Publication
(10) Pub. No.: US 2011/0299472 A1
(43) Pub. Date: Dec. 8, 2011

(54) Adaptive Synchronization scheme for wireless communication systems

(76) Inventor: Praveen Kumar, Bangalore (IN)

(21) Appl. No.: 13/201,911

(22) PCT Filed: Feb. 11, 2010
(86) PCT No.: PCT/IN10/00076

§ 371 Date: Aug. 17, 2011

(30) Foreign Application Priority Data
Feb. 23, 2009 (IN) 161/CHE/2009

(51) Int. Cl. H04W 4/00

(52) U.S. Cl. 370/328

(57) ABSTRACT

A method and system for synchronization in a wireless communication network using a plurality of synchronization frames (SF) and ciao frames (CF) distributed across a configurable period, termed as synchronization activity period (SAP) is disclosed. The periodicity of the SAP could be configured, to align with the data exchange periodicity. The length of the SAP is configurable; it is directly proportional to its periodicity and inversely proportional to the number of attempts and duration the unsynchronized nodes will make to listen to the synchronization information. This method provides a mechanism in which the network can configure the synchronization periodicity based on the data exchange periodicity and also it distributes the synchronization load among all its associated nodes to optimize the power efficiency.

### FIELD OF THE INVENTION

This invention relates to the field of synchronization of all nodes in a wireless communication network.

### BACKGROUND OF THE INVENTION

A wireless communication network (WCN) is a network that allows wireless connectivity between distributed nodes. Today there are many form of wireless communication networks (WCN) are available, to cater different types of need. A wireless personal area network (WPAN) is a simple, low-cost, easy to install with reliable data transfer and for short-range operations. Such WPAN normally comprises of a personal area network controller (PC), router nodes (RNs) and network elements (NEs). The PC and RNs are full function devices, which have the capability of getting associated with any full function device as well as it, can also allow other devices to associate with it. The NEs are reduced function device which can associate with any said full function device but it cannot allow any device to associate with it. These different types of devices in a network help it grow multiple hops also called as depth in this document. Another form of WCN is wireless sensor network (WSN) which is a network of wirelessly connected devices that use sensors to monitor physical or environmental conditions. Such physical or environmental conditions include, but are not limited to, temperature, sound, vibration, pressure and motion. Typically, a WSN could include a personal area network controller (PC), router nodes (RN), and wirelessly connected reduced function nodes, referred to as network elements (NE). In small range network, star topology is sufficient and a single coordinator (PC) manages the whole network. Large network normally uses tree or mesh topology, which consists of single PC and at least one RN or NE. Full function devices allows other full function devices and reduced function devices to associate with it to be part of network and helps the network to grow. The node which has associated other nodes is also called as parent node of the associated nodes and the associated nodes are called as child nodes. Child nodes of same parent are called as peer nodes with respect to each other. Typically, the NEs, RNs and PC are battery powered. A wide range of applications can be developed using this technology. As an example, applications in defense can be battlefield surveillance and equipment monitoring, for environmental and habitat monitoring, an application can be developed and installed under the sea and river to monitor pollution level, in healthcare applications it can monitor patient behavior and report the same to hospital, home automation, industry automation and traffic control are another major domain in which WSN can play major role. Many such applications are time sensitive and it is important that all nodes are time synchronized with the PC.

As per existing low rate wireless personal area network standard IEEE 802.15.4, the preamble bits are 4 octets, which can be transmitted in 128 microseconds on 2.4 GHz band. For the clock drift of 40 part per million (ppm), the synchronization shall happen periodically in less than 2 seconds otherwise the drift of the NEs will be more than the preamble bits and it will not be able to synchronize its frequency with the coordinator. Synchronizing at such a high periodicity will be an overhead for the systems where the data exchange rate is lower than the synchronization periodicity. Another issue with existing algorithms in synchronization is that it is fully parent's responsibility to synchronize all its associated nodes. In large networks the coordinators (PC, RN) have large data to process and propagate in addition to the responsibility of synchronization; this will drain its battery faster than NEs. In this invention we have developed an algorithm to share the coordinator's synchronization load by all its associated NEs.

### SUMMARY OF INVENTION

This invention provides an adaptive synchronization scheme which chooses the appropriate algorithm and also can be configured based on its current condition to give maximum power efficiency. In this invention we have introduced a concept of Ciao Frame (CF) which will be transmitted by the child nodes after listening to synchronization information from its coordinator. CF will be used for two purposes; i) as an acknowledgement for reception of synchronization information and, ii) as synchronization information for unsynchronized nodes. All the nodes which listened to the synchronization information transmitted from its parent or peer node shall transmit the CF. Irrespective of the access technology used; all the nodes which listened to the synchronization information shall transmit the CF after preconfigured time. Where access technology is not CDMA (Code Division Multiple Access), all the transmitted signals shall add constructively so that the receiving node is able to decode the CF data. In case the access technology used is CDMA, each node shall be assigned separate orthogonal code with which it shall multiplex its data before transmitting. In this case the parent node shall identify the nodes that have transmitted the CF and shall use it as acknowledgement for synchronization information. As part of association procedure each node shall be informed about the multiplexing code of all its peer nodes. An attempt shall be made to decode the data received at the time of synchronization using the code of all its peer and parent node. The CF also contains the synchronization information with respect to its current time. The CF is designed in such a way that all the synchronized nodes can transmit simultaneously with proper phase shift so that it adds constructively at most of its peer nodes. Multiple algorithms are described in this invention and each node shall choose the appropriate or combination of algorithms based on the scenario in which it is operating. The invention relates to a method and system of synchronization in wireless communication network. The operating environment varies for different networks or the same network can span across different environments; this invention proposes synchronization algorithm which is adaptive in nature for dynamic changes and also can be pre-configured depending on the network working environment. This invention also distributes the synchronization responsibility from the parent node to its synchronized child nodes without loosing in precision. Overall it reduces the synchronization overhead drastically than existing algorithms.

### BRIEF DESCRIPTION OF DRAWINGS

The present invention is illustrated by way of example, and not by way of limitation, in the figures of the accompanying drawings and in which like reference numerals refer to similar elements and in which:

FIG. 1 illustrates an exemplary wireless communication network (WCN).

FIG. 2 illustrates an exemplary time domain of a coordinator in the network.

FIG. 3 illustrates an exemplary format of synchronization and ciao frame;

FIG. 4 illustrates an exemplary value for frame type of synchronization and ciao frame;

FIG. 5 illustrates an exemplary time domain of all-in-range (AIR) network, that is all child nodes and parent node are in radio sphere of influence of each other and simultaneous transmission of ciao frame is possible;

FIG. 6 illustrates an exemplary time domain of not-all-in-range (NAIR) network, that is either all child nodes are not in radio sphere of influence of each other or simultaneous ciao frame transmission is not possible; in this figure it is illustrating the worst case where CF is not transmitted by any child node;

FIG. 7 illustrates an exemplary time domain of a NAIR network, similar to scenario in FIG. 6 but here occasionally CF is transmitted by the child nodes.

FIG. 8 illustrates an exemplary time domain of different types of node that is fast and slow clock drift compared to coordinator's clock.

FIG. 9 illustrates an exemplary flow chart of algorithm used for synchronization process.

### DETAILED DESCRIPTION OF INVENTION WITH RESPECT TO DRAWINGS

Various embodiments of the present invention provide a method and system for synchronization in a wireless communication network, especially in wireless ad-hoc communication networks. This should be taken as an example and not by limitation. In the following description, the present invention has been illustrated in the context of a wireless sensor network (WSN). However, it will be apparent to those ordinarily skilled in the art the applicability of the invention to many other wireless systems.

In a conventional WSN governed by the standard IEEE 802.15.4, the process of synchronization is achieved by the beacon frames (BF). Due to the limited length of preamble data (PD) available in the beacon frame, the beacon frame would require to be transmitted by the PC or RN (parent node) and received by the RN and NEs (child nodes) periodically, many more times than the data exchange periodicity. The other limitation of conventional network architecture is that it is always parent's responsibility to transmit the synchronization information for its child nodes to get synchronized with it. This invention proposes algorithms which enables the network to match the data exchange periodicity and the synchronization periodicity, and thus reduces the burden of synchronization; distributes the synchronization burden to its associated nodes; using acknowledgment method removes the unnecessary transmission of synchronization information when all the child nodes are already synchronized and introduces synchronization activity logging mechanism which helps in reducing the number of attempts made for synchronization by child nodes.

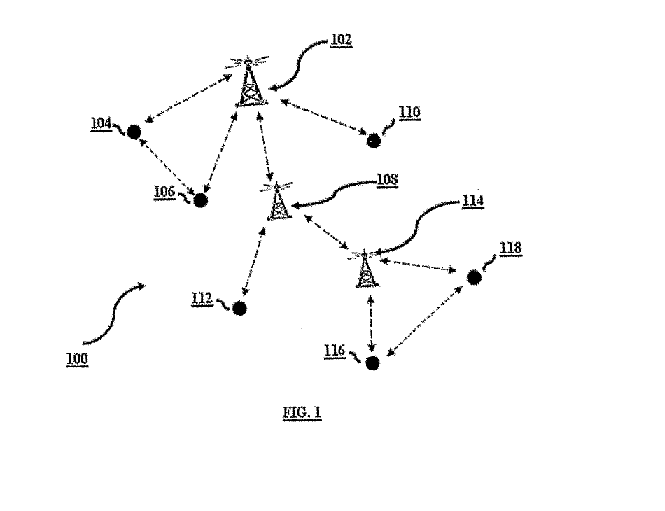

FIG. 1 illustrates an exemplary wireless communication network 100. 102 is illustrated as PC; 104, 106, 108 and 110 are associated with PC where 104, 106 and 110 are reduced function device NEs and 108 is a full function device RN. As illustrated, RN 108 allows further level of association with it. 112 and 114 are associated with RN 108, where 112 is a NE and 114 is a RN. RN 114 further allowing network to grow by associating 116 and 118. In this manner network can grow multiple hops and covers the required area. The bi-directional arrows denote that the nodes are in their radio sphere of influence and can communicate with it.

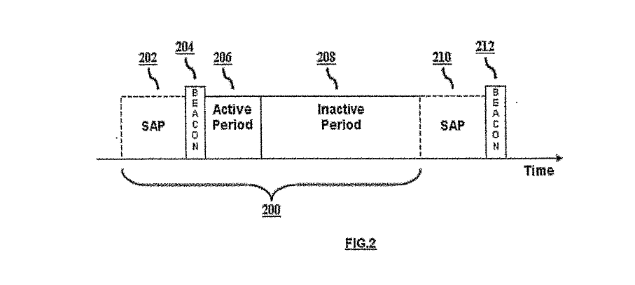

FIG. 2 illustrates a typical time domain of a parent and its child nodes; this repeats periodically. As illustrated 200 is superframe, the time period between two consecutive starts of synchronization activity period (SAP). Synchronization activity period (SAP) 202 is the period in which synchronization activity (SA) shall happen. After SAP, the normal as per IEEE 802.15.4 standard the frame follows, which contains Beacon Frame (204), active period (206) followed by inactive period (208). The duration of SAP depends on multiple factors such as synchronization periodicity, maximum relative clock drift rate with respect to its coordinator, depth from the PC, active period duration in the superframe and the receiving node's method of listening. The reception method of child node can be configured in multiple ways to listen to the synchronization frame (SF): i) Single Attempt Reception (SAR)—in this method the child node based on its clock starts listening to SF and continues in reception mode till it receives the SF or concludes that it missed the synchronization frame in that particular SAP; ii) Multiple Attempt Reception (MAR)—in this method the child node tries to listen to SF for certain period of time tₘᵢₙ, if it doesn't find any signal in that period then the node goes for short sleep duration T_{SS} and then reattempts. This short sleep T_{SS} and then reattempt shall happen for preconfigured times (numTry) before it conclude that its clock is faster than the parent node and then it shall go to long sleep T_{LS}. After the expiry of long sleep T_{LS}, the node shall again attempt to listen to synchronization information (as described above for numTry times). This whole process shall continue for configurable period rxAttempt of times. In case if the node doesn't get synchronized in all its attempt then it shall conclude that it missed the synchronization opportunity and shall take defense mechanism for next opportunity.

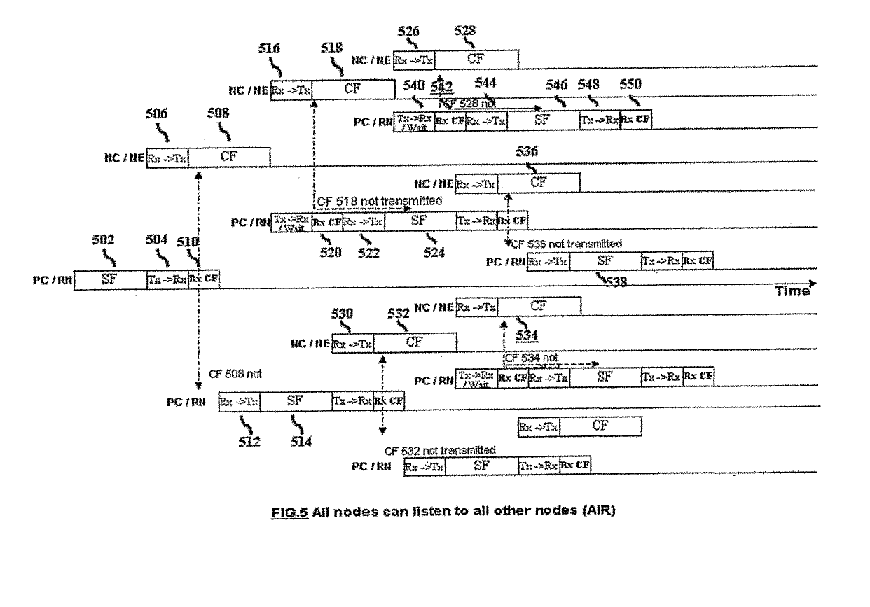

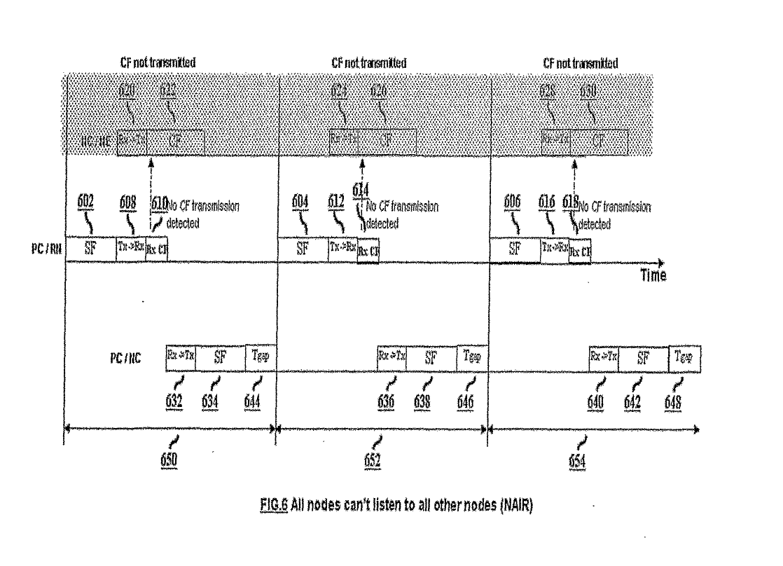

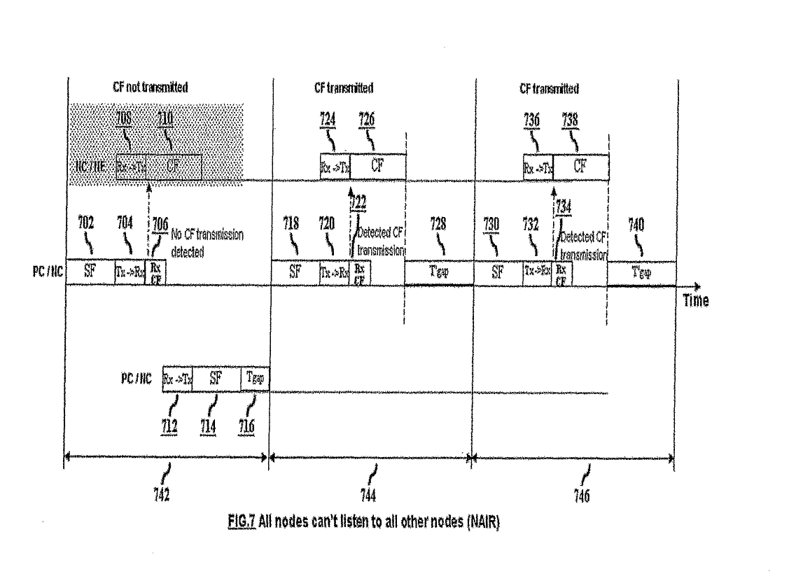

In SAP the parent node will transmit the SF multiple times as illustrated in FIG. 5, FIG. 6 or FIG. 7, depending upon its configuration and environmental conditions. The child nodes, which is expecting SF from its parent shall attempt to listen to SF based on the above mentioned SAR or MAR method. Upon reception of SF, the child node shall get synchronized and then transmit the CF after pre-configurable period of time (normally after turn-around time) T_{TA}. The environmental condition of parent node can be broadly classified as of two types: i) All-in-range (AIR)—in this case all child nodes are in radio sphere of influence of each other nodes; also this scheme is applicable only when all the associated nodes can transmit the CF simultaneously without interfering each other. Simultaneous transmission of CF is possible in the case when the transmitting nodes are transmitting its data after multiplexing it with unique orthogonal codes or by setting the phase shifts appropriately so that the transmitted data adds constructively at all the receiving nodes. ii) Not-all-in-range (NAIR)—in this case all child nodes are either not in range of all other nodes associated with that parent or simultaneous transmission of CF from multiple nodes may generate noise to some of the unsynchronized peer nodes. Since the CF is transmitted by the child nodes, which is also used for synchronization by the unsynchronized peer nodes, it is important to check the orientation of all the nodes and then choose the appropriate synchronization scheme. FIG. 5, FIG. 6 and FIG. 7 illustrates the SAP zone for different working environments i.e. AIR and NAIR.

In this document, as an example the synchronization schemes are described for one level only, i.e. one parent and its child nodes. This should be taken as an example and not by limitation; the algorithms can be extended to multiple layer network.

FIG. 5 illustrates the AIR networks, where all the nodes can listen to all its peer nodes and simultaneous transmission of CF from multiple nodes is possible without interference. In AIR case the method used by parent node is that it shall start the synchronization activity (SA) by transmitting the SF, check if any of its child nodes is transmitting the CF after the preconfigured period T_{TA}, if any of the child node is transmitting then go to sleep mode till next SF or CF slot; if none of its child nodes is transmitting the CF then retransmit the SF after preconfigured period. This process shall continue till end of SAP or all the associated nodes are synchronized. This concept has been again described more elaborately below.

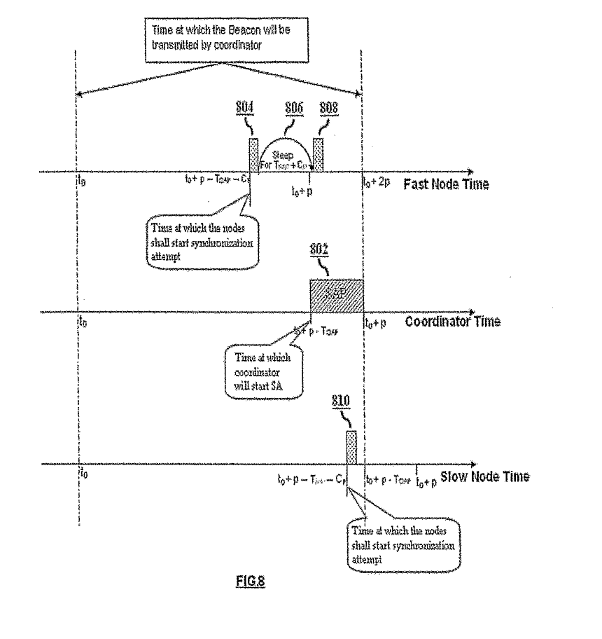

As illustrated in FIG. 5, based on its clock the parent node starts the synchronization activity by transmitting SF 502 at SAP period before the beacon. Since the parent node takes the responsibility to cover the entire SAP or till all its child nodes get synchronized to transmit the synchronization information, it keeps checking whether the CF is getting transmitted by any of its child nodes or not, 510, after preconfigured time T_{TA} 504. If the parent node finds that at least one of its child nodes is transmitting the CF 508, then it goes to sleep or low power consumption mode till the next slot for CF 520; but if the coordinator doesn't find any CF from its child nodes, then it transmits again the SF 514 after preconfigured turn-around time T_{TA} 512. At the receiver side, the child nodes shall start its synchronization process assuming maximum possible clock drift supported by the network ‘d’ and configurable period C_{P} as margin. Value of C_{P} can be configurable, as an example if its value is equal to two synchronization cycles (s) i.e. 2*s, the node will get four opportunities to get synchronized with its parent. Synchronization cycle ‘s’ means that the time period in which at least a pair of SF-CF or two SFs or two CFs must be transmitted. Hence the child nodes shall start its synchronization process at p*d+C_{P} time before the end of SAP according to its clock; where p is the SAP periodicity i.e. time period between two consecutive SAPs, d is the maximum clock drift supported and C_{P} is the configurable period. The child nodes which successfully receive the SF 502 shall synchronize its frequency and time with its parent and shall transmit the CF 508 after turn-around time 506. 504 and 506 is the turn-around times were nodes change its transceiver mode. The parent node shall change its transceiver mode to reception while the nodes which listened to SF successfully shall change its transceiver mode for transmitting CF. As shown in FIG. 5, the parent node will listen to the initial portion of CF 510 to find out whether the CF is getting transmitted or not and also to keep the record of nodes which transmitted the CF. If the parent doesn't find any CF 508 then it changes its transceiver mode to transmission during 512 and then transmits the SF 514. In case if the parent node finds the CF, it will go in low power consumption mode till the next CF 518 slot and then again wake up at 520 and try to listen for next CF. This sequence of transmission of SF or CF will continue till either the SAP period is over or the coordinator receives the CF (acknowledgment) from all its child nodes. In this scenario, in worst case when the child node attempts to get synchronized in SAP period, the node will have to be continuously ON for t_{SF}−t_{PD}+t_{TA}+t_{R×CF}+t_{TA}+t_{SF} period to get synchronized, hereafter this period is termed as T_{RX}. As per IEEE 802.15.4 standard and proposed frame format, this period (T_{RX}) will be equal to 1.344 millisecond. Said t_{SF} is SF period, t_{PD} is preamble data (PD) period of SF, t_{TA} is transceiver turn-around time, t_{a×CF} is period for which the parent shall listen to CF to make out whether its child node(s) are transmitting the CF or not, as well as if possible, sufficient to identify the transmitting node(s). The fast node when it will attempt to listen to the SF or CF keeping the two synchronization cycle period margin according to its clock, it will be much ahead of SAP period and will not be able to receive any synchronization information as illustrated in FIG. 8 804. The node shall normally conclude that it is not in SAP zone, if it does not receive any signal after continuous scanning the frequency channel for the period of t_{TA}+t_{R×CF} t_{TA}+(1 octet time) i.e. for tₘᵢₙ period. But to make the system robust the node shall attempt listening to SF, continuously for tₘᵢₙ period for pre-configurable number of times numTry. In case if node doesn't find any synchronization information in all its try, it shall then go for long sleep of the duration T_{LS}=T_{SAP}+C_{P} if it is the first long sleep otherwise for T_{SAP} duration; and then again try to listen to the SF as illustrated in FIG. 8. T_{SAP} is the length of SAP which shall be calculated based on the equation 1 or 2 described below based on the condition. This algorithm is again described in the form of flow chart in later part of the section.

After synchronization the child node will transmit the CF single or multiple times depending upon configuration, which shall give unsynchronized nodes multiple opportunities to get synchronized. As mentioned earlier, the period of SAP depends on the maximum clock drift need to support, how the personal area controller (PC) node is synchronized, the duration and the number of attempts the child node will do to listen to the synchronization information, the depth from the PC and the periodicity of SAP. The way the PC is synchronized is important because if the PC node is synchronized using global positioning system (GPS) then the relative drift between the synchronized parent node and the child node will be just the maximum possible drift of the child nodes, but if the PC is not GPS synchronized then the drift of PC node shall also be considered. The other factor, number of attempts the child node shall make to listen to synchronization information is also important factor to calculate the SAP length, since each increase in attempt count will reduce the SAP length by half. The formula below calculates the SAP length at nth layer from the PC when the is the synchronization periodicity:

$$S A P length = ( \frac{2 Δ + 2 {Δ}_{PC}}{rxAttempt} ) [ {T}_{sync} + ( \frac{{( 1 + A )}^{n} - 1}{A} ) ( A * {T}_{sync} + B ) ] \qquad equation 1$$

where
n=0, 1, 2, . . . l(maximum possible depth)
Δ=maximum node drift
Δ_{PC}=max imum PC drift
rxAttempt=1 or 2, it is number of attempts the node will do to listen to Synchronization Information

### T_{sync}=Synchronization Periodicity

T_{Act=Active time period}
T_{TA}=Turn around Time

$$A = \frac{4 Δ}{1 - Δ}$$

$$B = ( \frac{1}{1 - Δ} ) ( {T}_{Act} + {T}_{TA} )$$

The above formula assumes that the PC is not GPS synchronized. In case the PC is GPS synchronized then the value of Δ_{PC} will be equal to 0 and the equation 1 will look like:

$$S A P length = ( \frac{2 Δ}{rxAttempt} ) [ {T}_{sync} + ( \frac{{( 1 + A )}^{n} - 1}{A} ) ( A * {T}_{sync} + B ) ] \qquad equation 2$$

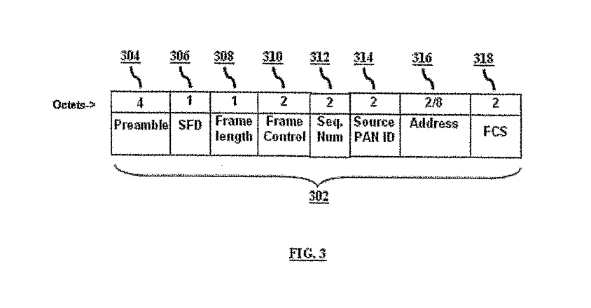

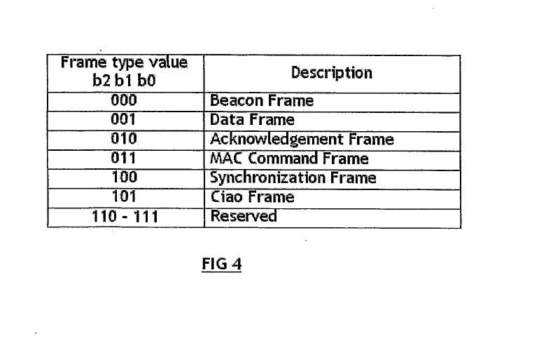

As mentioned, a new format of synchronization frame (SF) and a new frame type called as ciao frame (CF) 302 are introduced in this invention to achieve all the mentioned objectives as illustrated in FIG. 3. Other than the value of frame control field 310, the frame format of both SF and CF is same as illustrated in 302. The new values for frame type to indicate the SF and CF is shown in FIG. 4. Last two entries, value 100 for synchronization frame and value 101 for Ciao Frame is introduced to support this invention. As discussed above that multiple SF will be transmitted during the SAP, the sequence Number 312, shall contain the relative time at which beacon will be transmitted, which is different than its conventional use specified in IEEE 802.15.4. As per convention, the source personal area network (PAN) ID 314 and the Address field 316, will contain the parent's information in case of CF. The new ciao frame (CF) format is exactly same as SF format except that the frame type value in frame control field 310 to indicate that it is CF or SF; this will help in indicating that current synchronization information (i.e. SF or CF) is transmitted by parent or peer node. In case if the channel access technology uses orthogonal codes to multiplex data before transmission, the code shall be used to detect which all associated nodes have transmitted the CF. In case if the coordinator finds that all the child nodes have transmitted CF, i.e. all the nodes have synchronized, then it shall stop its synchronization activity.

Unless mentioned all the values in this document is calculated assuming short address i.e. 2 octet address field is used in transmission.

FIG. 6 and FIG. 7 illustrates the NAIR case, i.e. where all the child nodes of a parent cannot listen to each other directly or the simultaneous transmission of CF can interfere. In this case the CF transmitted by some node may not be listened by some other nodes and hence the SF shall be transmitted periodically by the parent. As illustrated in FIG. 6 and FIG. 7 the SF is transmitted periodically at 602, 604 and 606 or 702, 714, 718 and 730. Both the figures illustrate the same scenario that is when all nodes are not in range of each other. FIG. 6 is highlighting the worst case scenario when there is no CF transmission from the child nodes while FIG. 7 illustrates the normal condition when occasionally CFs is transmitted by the child nodes. The shaded portions in the figures illustrate the event which didn't happen. As illustrated in the figures, similar to above network scenario, in this scenario also the child nodes which listened to SF or CF successfully shall synchronize its frequency and time and shall transmit CF in next CF slot, shown as 622, 626 and 630 or 710, 726 and 738. As illustrated in FIG. 6 and FIG. 7 the periodicity of SF is constant 650, 652, 654, or 742, 744, 746 all are of same duration. The value of T_{gap} (644, 646, 648 or 716) and T′_{gap} (728 and 740) shall be designed in such a way that periodicity of SF i.e. synchronization cycle is constant for all the scenarios, whether the CF is transmitted or not i.e. T_{gap} and T′_{gap} are the silent periods to make the synchronization cycle of constant period in different scenarios. T_{gap} is when CF is not transmitted whether as T′_{gap} is when the CF is transmitted. As in previous case, if the CF is not transmitted then the parent transmits the SF as shown by 634, 638 and 642 or 714. Parent node checking the CF transmission after its SF transmission are illustrated as 610, 614 and 618 or 706, 722 and 734; if it doesn't find any CF then it transmits the SF as at 634, 638 and 642 or 714 but if it finds CF transmission as at 726 and 738 then it waits till the next slot of SF 730.

FIG. 8 illustrates the time domain of different nodes having different clock drifts and their actions for synchronization. This figure illustrates the case where child nodes are configured to make two attempts i.e. rxAttempt=2, to get synchronized, which shall be taken as an example and not as its limitation. As mentioned in said equations 1 and 2, the SAP length can be calculated for any number of attempts (r×Attempt). 802 is the time period where parent does its synchronization activity (SA). The terms used in this algorithm are ‘p’ which stands for SAP periodicity i.e. equivalent to a superframe duration; ‘s’ stands for synchronization cycle illustrated as 650, 652 and 654 or 742, 744 and 746, its value will be equal to t_{SF}+t_{TA}+t_{R×CF}+t_{TA}+t_{SF}+T_{gap} period; ‘d’ stands for the maximum clock drift rate which the network shall support, as per IEEE 802.15.4 the network shall support clock drift up to 40 ppm; ‘D’ stands for total drift in a superframe, which will be equal to p*d; and N stands for the number previous consecutive SAPs the node missed to get synchronized. These attributes will be same for both types of network i.e. AIR or NAIR network. The SAP duration (T_{SAP}) shall be calculated based on the scenario i.e. how the PC is synchronized, using either of the equations 1 or 2 for different configurable parameters. As per the algorithm the child node shall try to listen to SF, assuming its clock having maximum drift (negative i.e. clock is slow) multiplied with the time elapsed since the last synchronization plus a configurable period C_{P} as margin i.e. p*d*(N+1)+C_{P} time before the expected end of SAP as per its clock. For the child nodes having faster clock drift with respect to the parent clock, the attempt will be made at 804 i.e. at p−(N+1)*D−C_{P} of parent clock, and at this point of time the parent node would not have started its SA. Normally, in error free environments and nodes working ideally, the child node shall listen for tₘᵢₙ time, 804, continuously and if it doesn't find any signal at any point of time in tₘᵢₙ period then it shall conclude that its clock is fast and it shall go to long sleep 806 of T_{SAP} C_{P} duration if it was the first attempt otherwise for T_{SAP} period and then again after elapse of T_{LS} it shall activate itself to listen to the synchronization information. As mentioned earlier, this method can be configured for multiple attempts. However, to make the system robust the node shall attempt to listen to synchronization information multiple times, which shall be a pre-configurable value numTry, before concluding that it is ahead of SAP. Between the attempts it shall go to short sleep for any configurable period T_{SS} but preferably less than a synchronization cycle i.e. s. Even after attempting for the pre-configured number of times numTry, if it does not find any synchronization information, then it shall conclude that it is ahead of SAP and shall go for long sleep of duration T_{LS}=T_{SAP} C_{P} if it was the first attempt otherwise for T_{SAP} period, and then again attempt to listen to SF 808. This process shall continue for the pre-configured number of times rxAttempt*(N+1), where rxAttempt is the number of attempt the child node makes to listen to synchronization information in the case when the node had successfully synchronized in previous SAP and N as mentioned earlier is the count of previous consecutive SAPs the child node had missed to synchronize. Normally by the last attempt, the node shall get synchronized unless there is very high level of noise in the channel. The lesser the drift will be, the lesser the attempt the node will have to make. Similar to the fast clock node the slow clock node behavior is also illustrated. As shown if the node clock is slow to its maximum level, it will attempt to listen to the SF at p−(N+1)*D−C_{P} time as per its local clock; but since its clock is slow, it will lie in SAP as shown in FIG. 8 by 810. Normally if there is no severe noise on the synchronization channel, in the first attempt of listening for continuous tₘᵢₙ period, the child node will find either of SF or CF and continue listening till it gets synchronized.

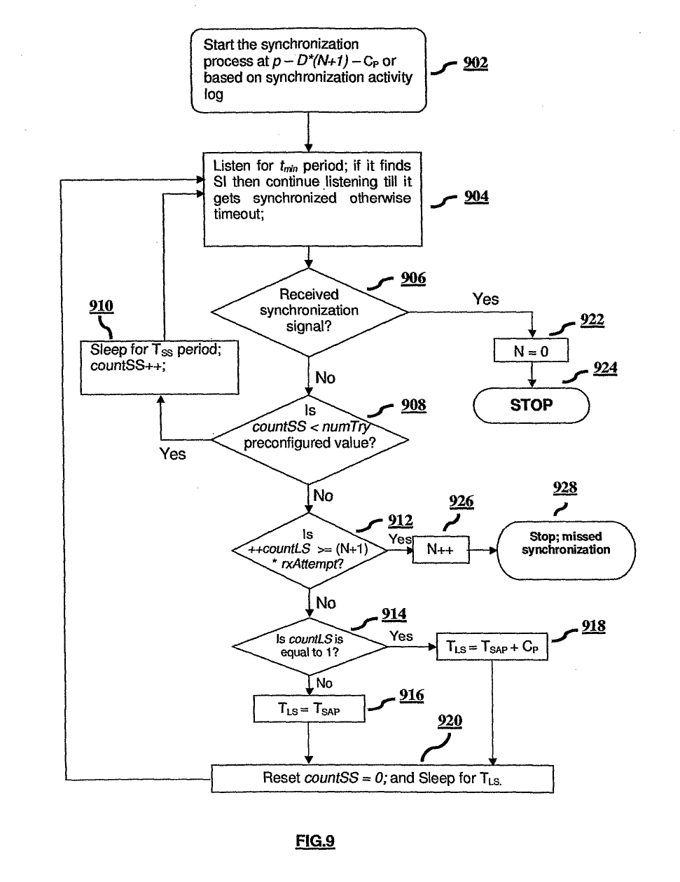

FIG. 9 illustrates said above algorithms used by the unsynchronized nodes at the time of attempting for getting synchronized with its parent using a flow chart diagram. The child nodes shall start its synchronization process at p*d*(N+1)+C_{P} time before the expected end of SAP as per its clock, 902. At this point the child node shall reset its counter values countSS and countLS to zero, which will keeps track of number of attempts made after short sleep and long sleep respectively. As mentioned, two types of sleeps are designed, short sleep T_{SS} which is of configurable duration preferably less than a synchronization cycle and long sleep of duration T_{LS} equal to T_{SAP}+C_{P} after the first attempt otherwise equal to T_{SAP}. Once the synchronization process is triggered, the child nodes will continuously listen for tₘᵢₙ period; if it finds the relevant synchronization signal then it shall continue listening till it gets synchronized and hence the child node state will change from 906 to 924 through 922, otherwise check the value of countSS 908, if its value is less than the preconfigured value numTry then go for short sleep 910, increment the value of countSS and then again try to listen to synchronization information 904. If the countSS value matches the preconfigured value numTry then it shall assume that the node is ahead of SAP and then it shall check the long sleep possibility 912. The child node checks the value of countLS, if its value is less than preconfigured value rxAttempt*(N+1) then the node shall go to long sleep T_{LS} and after which it shall again attempt to listen to synchronization information 904. This whole sequence of process shall happen till either the node gets synchronized i.e. reaches 924 or countLS matches rxAttempt*(N+1) value and in which case it shall assume that it missed the synchronization opportunity in current SAP and shall increment the value of N.

As mentioned, as part of defense mechanism in case of failure of synchronization in any SAP, the child node shall increase the number of attempts to listen to the synchronization information in the next SAP and also it shall start its synchronization activity in advance to accommodate the additional maximum possible drift since the last synchronization. The number of attempts the child node shall make to listen to synchronization information shall be equal to the number of attempts (rxAttempt) the child node makes in case of successful last synchronization multiplied with the number of previous consecutive SAPs the node missed to get synchronized in addition to current SAP's attempt i.e. it will be equal to (N+1)*rxAttempt; where N is previous consecutive SAPs the node missed to get synchronized. As mentioned earlier that in this case the child node shall start its synchronization activity much ahead than in normal conditions, in this case the child node shall start its synchronization activity at the time elapsed since the last synchronization multiplied with the maximum possible drift supported by the network plus the configurable period C_{P} before the end of SAP as per its clock i.e. the child node shall start its synchronization activity at d*(N+1)*p+C_{P}, where d is the maximum possible drift, N is the number of SAPs the node missed to get synchronized, p is the superframe duration. The other parameters of the synchronization method shall remain as it is in normal condition i.e. the value of T_{LS} shall be equal to T_{SAP}+C_{P} after the first attempt and afterwards it shall be equal to T_{SAP}.

The present invention also introduces synchronization activity logging method which shall reduce the number of attempts made to listen to the synchronization information. As part of the present invention all the nodes shall keep record of its synchronization activity, such as past clock drifts, the clock drifts at different battery power level, temperature, pressure and all the parameters which it is capable of sensing and can affect the clock drift. While attempting to listen to SF, it shall use the synchronization activity log (SAL) to estimate its present drift and then accordingly attempt to listen to SF so that it gets synchronized in minimum attempts.

What is claimed is:

1. A method for synchronization in a wireless communication network, comprising the steps of:
creating a synchronization frame (SF) by the synchronized personal area network controller (PC) or router node (RN) in synchronization activity period (SAP) i.e. the synchronized parent node creating a synchronization frame to synchronize its child nodes;
transmitting the synchronization frame by said parent node for its unsynchronized child nodes i.e. for the router nodes and network elements associated with said synchronized parent node in the wireless communication network;
said unsynchronized child nodes receiving the synchronization frame and getting synchronized with parent node transmitting said synchronization frame;
said child nodes after getting synchronized, transmitting a ciao frame (CF) after a configurable turn-around time T_{TA};
said parent node monitoring after the preconfigured time whether said ciao frame is getting transmitted by at least one of its child node in the network and
on detecting said ciao frame, the parent node changing its transceiver mode into low power consumption mode till the next synchronization frame slot or the ciao frame slot;
on failing to detect any said ciao frame, the parent node changing its transceiver mode to transmission and transmitting the synchronization frame after said turn-around time T_{TA},
whereby synchronization is achieved power efficiently by able to configure the synchronization periodicity and by synchronized child nodes sharing the synchronization process burden.

2. The method, as claimed in claim 1, wherein the synchronized child node transmitting said ciao frame after getting synchronized, to be used as synchronization information (SI) similar to synchronization frame by the unsynchronized child nodes of the same parent.

3. The method, as claimed in claim 1, wherein the length of synchronization activity period (SAP), is configured by said personal area network controller (PC) for its network based on factors comprising,
maximum allowable clock drift rate supported by the communication protocol stack for the associated nodes;
maximum allowable clock drift rate of the personal area network controller (PC);
the superframe duration (T_{superframe}), which is the time period between two consecutive synchronization activity periods;
the number of attempts (rxAttempt) the child node will make to listen to its parent transmitted synchronization frame or ciao frame transmitted by the synchronized child nodes associated with the same parent;
the duration for which the unassociated child node will try to listen to the synchronization information in each of its said attempt (rxAttempt);
the depth of the node from the personal area network controller, and
the active period at each layer of the network.

4. The length of the synchronization activity period as claimed in claim 1, is directly proportional to the superframe duration (T_{superframe}), the maximum allowable clock drift rate of the associated nodes the wireless communication network shall support, the maximum allowable clock drift rate of the personal area network controller (PC), the depth of the synchronization frame transmitting node and the active period at each layer of the network.

5. The length of the synchronization activity period as claimed in claim 1 is inversely proportional to the number of attempts (rxAttempt) and the duration for which any unsynchronized child nodes will make to listen to the synchronization information i.e. synchronization frame or ciao frame.

6. The transmission of ciao frame (CF) carried out by the synchronized child nodes as claimed in claim 1 is intended to synchronize all the unsynchronized child nodes associated with its parent node, based on the factors comprising
(i) the ciao frame being decodable by all said unsynchronized child nodes or not, in case of simultaneous transmission of the ciao frame from multiple child nodes and
(ii) the orientation of all the child nodes with respect to each other;
said nodes being classified as either all-in-range network (AIR) or not-all-in-range network (NAIR).

7. The all-in-range network (AIR) as claimed in claim 6 comprising simultaneous transmission of ciao frame made from multiple child nodes being decodable by all the child nodes and wherein all the child nodes are in radio sphere of influence of said ciao frame transmitting nodes.

8. The not-all-in-range (NAIR) network as claimed in claim 6 wherein either simultaneous transmission of ciao frame from multiple child nodes is not decodable or all the child nodes are not in radio sphere of influence of said ciao frame transmitting node and wherein said parent node shall transmit the synchronization frame periodically after preconfigured time called as synchronization cycle period (SC).

9. The method for synchronization in wireless communication network, as claimed in claim 1, comprising the unsynchronized child nodes starting the synchronization process (at configurable period C_{P} plus the maximum possible drift since the last synchronization) before the end of synchronization activity period as per its local clock, and
wherein, the unsynchronized node, tries for preconfigured times (numTry) with the gap of configurable duration called as short sleep T_{SS} to listen to synchronization information (SI) before concluding that there is no synchronization information currently transmitting on the channel;
on successful reception of said synchronization information, the unsynchronized nodes get synchronized and transmits the ciao frame after configurable turn-around time T_{TA} and where it fails to receive any synchronization information in all of its numTry attempts it shall go to low power consumption mode for long sleep duration T_{LS} and then reattempt to listen to synchronization information;
the whole process continuing till either the node gets synchronized or the number of attempts equal the pre-configurable number of attempts (rxAttempt) the node shall make in a synchronization activity period (SAP) when it was synchronized successfully in previous synchronization activity period plus said configurable number of attempts (rxAttempt) multiplied with the number of previous consecutive synchronization activity periods (N) the node missed to get synchronized (i.e. for rxAttempt+rxAttempt*N),
whereby unsynchronized child nodes get synchronized with its parent even if it had missed the synchronization opportunity previously.

10. The method, as claimed in claim 9, wherein said long sleep T_{LS} shall be equal to synchronization activity period length T_{SAP} plus said configurable period C_{P} after the first reception attempt (rxAttempt) and thereafter the T_{LS} shall be equal to synchronization activity period length T_{SAP}.

11. A method of logging the time synchronization activities by each node in the wireless communication network, wherein each node shall record all its synchronization activity event including
past clock drifts;
the clock drift rate at different battery power level;
the clock drift rate at different temperature, and
the clock drift rate at different pressure
whereby the node will able to estimate its present drift based on present condition and minimize its attempt for synchronization process.

12. Each node in the wireless communication network while attempting to listen to synchronization frame shall use said synchronization activity log as claimed in claim 11 to estimate its current drift and then adjust its attempt to listen to synchronization frame so that it gets synchronized in minimum number of attempts.

13. A system for synchronization in a wireless communication network comprising
a personal area network controller and a network element;
means for creating a synchronization frame (SF) in synchronization activity period;
means for transmitting the synchronization frame to said unassociated child nodes;
means for, transmitting a ciao frame by the synchronized child nodes after a configurable turn-around time T_{TA};
means for receiving synchronization information from said synchronized nodes;
means for monitoring said child node response for said transmitted synchronization information and verifying whether all child, nodes have been synchronized with the network or not;
means for verifying whether said ciao frame is getting transmitted by at least one of its child node in the network, and
means for power savings and efficient power utilization by making the parent node to change its transceiver mode into low power consumption mode till the next synchronization frame or the ciao frame slot, i.e. till next synchronization information slot;
whereby synchronization is achieved with efficient power utilization by configuring the synchronization periodicity and by getting the synchronized child nodes to share the synchronization process burden.

14. The system as claimed in claim 13 comprising a personal area network controller and a router node.

15. The system as claimed in claim 13 comprising a personal area network controller, a router node and a network element.

16. The full function device mentioned in claim 13 is a wireless networking device capable of networking with reduced function device or other full function device and it is capable to operate in three modes serving as personal area network controller (PC), a router node (RN) or a network element (NE).

17. The reduced function device mentioned in claim 13 is a wireless networking device capable of networking with only full function device and it can serve as network element (NE) in any network, it can also be called as end device in the network.

18. The network element, as mentioned in claim 13, wherein said network element is a reduced function device and is adapted to get associated as child node with a full function device such as personal area network controller or router node;
adapted to receive said synchronization frame in synchronization activity period as part of synchronization process with its parent node;
adapted to receive said ciao frame from its peer nodes in synchronization activity period as part of synchronization process;
adapted to transmit ciao frame after synchronization with its parent as part of synchronization process;
adapted to change to low power mode in case of idle to save the power;

19. The personal area network controller, as claimed in claim 13, wherein personal area network controller is a principal controller of the personal area network and is
adapted to create said synchronization frame in synchronization activity period as part of its child synchronization process;
adapted to transmit said synchronization frame as part of its child synchronization process;
adapted to monitor said ciao frame transmitted by its child nodes as part of its child synchronization process;
adapted to verify whether all the child nodes got synchronized or not as part of its child synchronization process;
adapted to change to low power mode in case of idle to save the power;

20. The router node, as mentioned in claim 14, wherein said router node is a full function device and is adapted to associate other router node and network element with it as its child node;
adapted to create said synchronization frame in synchronization activity period as part of its child synchronization process;
adapted to transmit said synchronization frame as part of its child synchronization process;
adapted to monitor said ciao frame transmitted by its child nodes as part of its child synchronization process;
adapted to verify whether all the child nodes got synchronized or not as part of its child synchronization process;
adapted to get associated as child with other full function device such as personal area network controller or router node;
adapted to create said ciao frame after receiving synchronization frame from its parent as part of synchronization process with its parent node;
adapted to transmit said ciao frame as part of synchronization process with its parent node;
adapted to change to low power mode in case of idle to save the power;
